(19) United States
(12) Patent Application Publication
(10) Pub. No.: US 2003/0037130 A1
(43) Pub. Date: Feb. 20, 2003

(54) Method and system for accessing computer systems in a computer network

(76) Inventor: Doug Rollins, Nampa, ID (US)

Correspondence Address: DORSEY & WHITNEY LLP, INTELLECTUAL PROPERTY DEPARTMENT, SUITE 3400, 1420 FIFTH AVENUE, SEATTLE, WA, 98101, US

(21) Appl. No.: 09/932,107

(22) Filed: Aug. 16, 2001

(51) Int. Cl. G06F 15/173

(52) U.S. Cl. 709/223; 709/218

(57) ABSTRACT

A computer administration system accesses computer systems in a computer network, each computer system providing and receiving operator interface data signals containing user output and input information. A plurality of system communications devices each communicate operator interface signals to and from a corresponding computer system. A remote access device includes a remote communications device that allows an administrator to select a computer system to be accessed and to communicate operator interface signals with the system communications device associated with the selected computer system. An operator interface device is coupled to the remote communications device in the remote access device and accepts user input and provides user output to allow the administrator to control the selected computer system via the communications devices.

### TECHNICAL FIELD

The present invention relates generally to computer systems, and, more specifically, to accessing computer systems in a computer network.

### BACKGROUND OF THE INVENTION

In today's technology-dominated world, nearly all businesses utilize computer networks to perform various functions that assist the officers and managers of the business in providing the products or services of the business. A computer network consists of a group of two or more computer systems that are linked together through a communications network, as will be understood by those skilled in the art. Nearly all medium and large sized businesses utilize computer networks to process accounting and financial information, and companies providing a technical product or service utilize computer networks to assist engineers and scientists in performing research and development of new products. In addition to businesses, many other types of organizations, such as colleges and universities, also utilize computer networks in performing a wide variety of tasks.

Typically, a business organization has a system manager or administrator that is given the responsibility of maintaining and updating the computer network, and depending on the size of the computer network a whole department including many individuals may be given this responsibility. In maintaining and updating the computer network, the system administrator will have the need, at least occasionally, to access each computer system in the network. For example, where the computer network is a server farm including a group of a network servers housed in one location, the system administrator will need to access each server and perform software updates, troubleshoot problems, and so on.

A typical computer network may include numerous computer systems, all of which must be accessible by a single system administrator or group of administrators. A number of conventional approaches have been utilized to allow a system administrator to conveniently access computer systems in the network. FIG. 1 is a functional block diagram illustrating a computer administration system 100 that allows a system administrator to access a plurality of computer systems 102A-N coupled together through a communications network 104 to form a computer network 106. Each of the computer systems 102A-N may be, for example, a server or other similar computer system. Each computer system 102A-N provides operator interface signals 108 that typically include keyboard, video, and mouse signals, which allow an operator to provide input to and receive output from the computer system via a keyboard, video display, and mouse, respectively, as will be appreciated by those skilled in the art.

In the system 100, the operator interface signals 108 of each computer system 102A-N are applied to a single keyboard/video/mouse (KVM) switch 110 that couples the operator interface signals of a selected computer system 102A-N to a video display 112, keyboard 114, and mouse 116 in response to control inputs 118 applied by a user (not shown). In operation, a user applies the control inputs 118 to the KVM switch 110 to select the desired computer system 102A-N. In response to the applied control inputs 118, the KVM switch 110 couples the operator interface signals 108 of the selected computer system 102A-N to the video display 112, keyboard 114, and mouse 116. The system administrator thereafter accesses the selected computer system 102A-N through the video display 112, keyboard 114, and mouse 116 and takes desired action on the computer system, such as the reconfiguration of system parameters or application programs. The KVM switch 110, video display 112, keyboard 114, and mouse 116 are typically located in the system administrator's office, allowing the administrator to access all of the computer systems 102A-N in the network 106 from a single location.

While the single KVM switch 110 and associated video display 112, keyboard 114, and mouse 116 provide a convenient single location for the system administrator to access all of the computer systems 102A-N, this single location is typically in the system administrator's office as previously mentioned and is thus physically separated from the computer systems. In many instances, it is desirable to be located physically near the computer system 102A-N when accessing the system, such as when the troubleshooting the system and when installing new hardware or software components. In the system 100, the KVM switch 110, video display 112, keyboard 114, and mouse 116 are immobile, meaning that a system administrator would need to physically walk back and forth between the location of the computer system 102A-N being accessed and the location of the KVM switch 110, video display 112, keyboard 114, and mouse 116 in such situations. The computer administration system 100 is also typically limited in the number of computer systems 102A-N that can be coupled to a single KVM switch 110. Thus, where a relatively large number of computer systems must be accessed, a single KVM switch 110 may not be used. As an alternative, multiple KVM switches 110 may be utilized but this increases the complexity of selecting the desired computer system 102A-N and also increases the cost of the system 100.

FIG. 1 also illustrates an alternative to the approach of the computer administration system 100 in which each computer system 102A-N has a dedicated operator interface device 120 coupled to the system, as illustrated only for the system 102N in the FIG. 1. This approach is expensive because the dedicated operator interface device 120, which typically includes a video display, keyboard, and mouse (not shown), must be purchased for each computer system 102A-N. A dedicated operator interface device 120 for each computer system 102A-N is ideally avoided since the computer systems need not be regularly accessed and thus the dedicated operator interface device goes unused most of the time. Moreover, the dedicated operator interface device 120 also occupies a relatively large amount of space, which may be at a premium in the facility housing the computer systems 102A-N.

FIG. 2 illustrates another conventional computer administration system 200 for providing a system administrator with access to a plurality of computer systems 202A-N interconnected through a communications network 204 to form a computer network 206. Each computer system 202A-N includes a remote access software component 208 that provides communications with a remote access system 210 over the communications network 204. More specifically, the remote access system 210 includes a remote access software component 212 that communicates over the communications network 204 with the remote access software components 208 running on the computer systems 202A-N. The remote access system 210 also includes a keyboard, video display, and mouse that allow the system administrator to provide input to and receive output from the remote access system.

In operation, the remote access software component 212 on the remote access system 210 allows the system administrator to select the computer system 202A-N to be accessed, and thereafter communicates over the communications network 204 with the corresponding remote access software component 208 on the selected computer system. The remote access software component 212 and remote access software component 208 operate in combination to allow the system administrator to access the selected computer system 202A-N over the communications network 204 as if the system administrator were using a keyboard, video display, and mouse directly coupled to the computer system. An example of a commercially available software package that may be utilized for the remote access software components 208, 212 is pcAnywhere, which is available from Symantec Corp., as will be appreciated by those skilled in the art.

In the system 200, the system administrator must install the remote access software components 208 on each computer system 202A-N in the computer network 206, which may be a relatively large number of computer systems. Moreover, the system administrator must maintain the remote access software components 208 installed on each computer system 202A-N, meaning that when software upgrades must be performed for each computer system in the computer network. As previously mentioned, in many instances it is desirable for the system administrator to be located physically near the computer system 202A-N being accessed. This is not typically possible with the administration system 200 since the remote access system 210 is typically located away from the computer systems 202A-N, such as in the system administrator's office.

### SUMMARY OF THE INVENTION

According to one aspect of the present invention, a computer administration system accesses computer systems in a computer network. Each computer system provides operator interface data signals containing user output information and receives operator interface data signals containing user input information. The operator interface data signals may be keyboard, video, and mouse signals. A plurality of system communications devices are each coupled to a corresponding computer system and operate in a transmit mode to receive the operator interface data signals from the corresponding computer system and to generate corresponding operator interface transmission signals. Each system communications device operates in a receive mode to receive operator interface transmission signals and to generate corresponding operator interface data signals that are applied to the corresponding computer system.

A remote access device includes a remote communications device that selects a system communications device and operates during the transmit mode to receive the operator interface transmission signals from the selected system communications device and to generate corresponding operator interface data signals. During the receive mode, the remote access device receives operator interface data signals and generates corresponding operator interface transmission signals that are applied to the selected system communications device. An operator interface device is coupled to the remote communications device and accepts user input and provides user output. The operator interface device generates user output in response to the operator interface data signals from the remote communications device, and applies corresponding operator interface data signals to the remote communications device in response to user input.

### BRIEF DESCRIPTION OF THE DRAWINGS

FIG. 1 illustrates a conventional computer administration system for accessing computer systems in a computer network.

FIG. 2 illustrates another conventional computer administration that utilizes an alternative approach for accessing computer systems in a computer network.

FIG. 3 illustrates a computer administration system for accessing computer systems in a computer network according to one embodiment of the present invention.

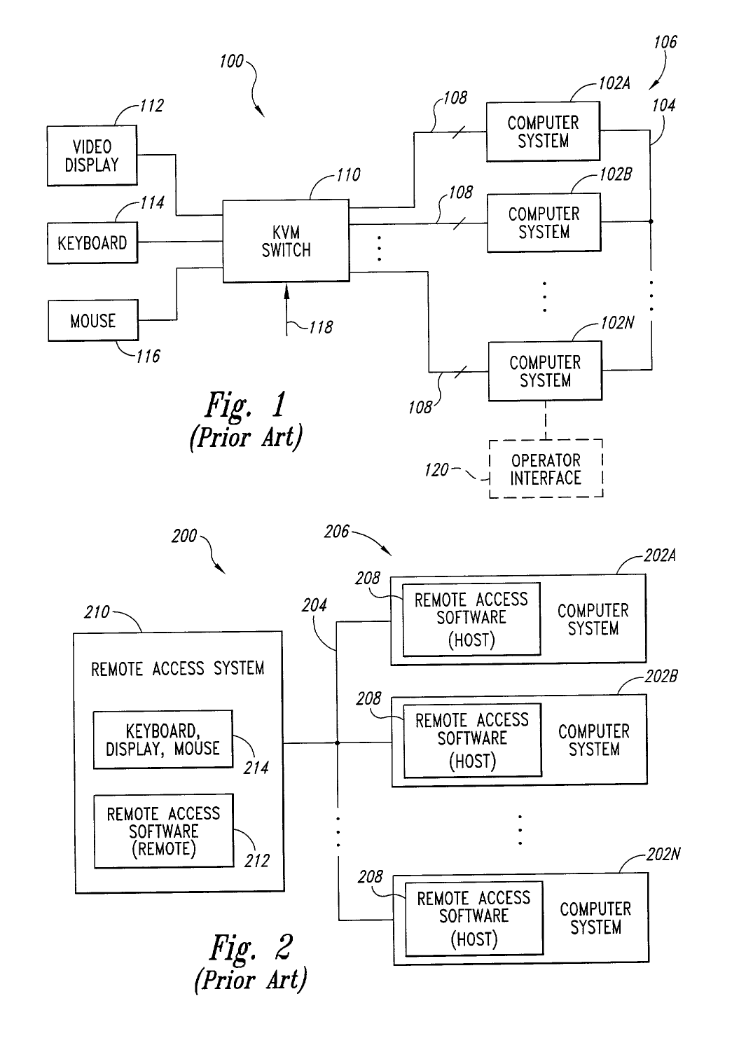

### DETAILED DESCRIPTION OF THE INVENTION

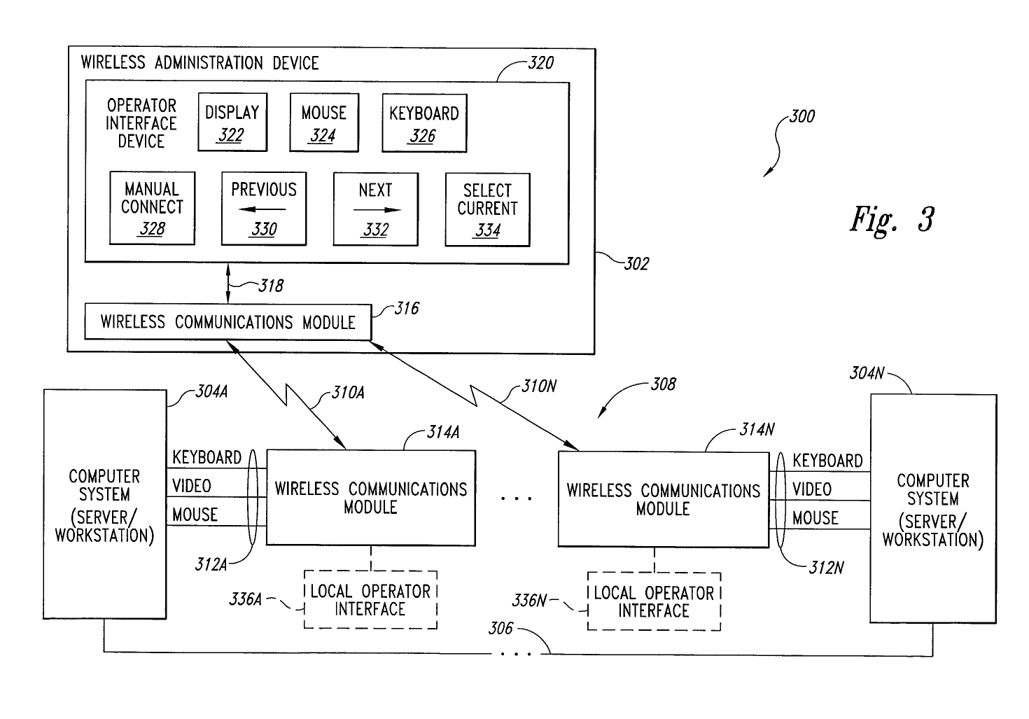

FIG. 3 is a functional block diagram of a computer administration system 300 including a wireless administration device 302 that allows a system operator to remotely control a plurality of computer systems 304A-N interconnected through a communications network 306 to form a computer network 308. The wireless administration device 302 is portable and communicates with the computer systems 304A-N through respective wireless communications links 310A-N, enabling a system administrator to control a selected one of the computer systems 304A-N when the administrator is proximate the selected computer system, which simplifies troubleshooting and updating for the administrator, as will be described in more detail below. In the following description, certain details are set forth to provide a sufficient understanding of the present invention. However, it will be clear to one skilled in the art that the present invention may be practiced without these particular details. In other instances, well-known software and hardware components and operations, along with ancillary circuits, signals, and communication protocols have not been shown in detail in order to avoid unnecessarily obscuring the present invention.

In the computer administration system 300, each computer system 304A-N applies corresponding operator interface signals 312A-N to a corresponding wireless communications module 314A-N. Each of the computer systems 304A-N may, for example, be a server or workstation. Once again, the operator interface signals 312A-N typically include keyboard, video, and mouse signals, and may include other operator interface signals as well, such as trackball or touch screen signals. The wireless communications modules 314A-N each operate in a transmit mode to receive the corresponding operator interface signals 312A-N and encode these signals to generate corresponding operator interface transmission signals that are then transmitted over the respective wireless communications links 310A-N. Each wireless communications module 314A-N also operates in a receive mode to receive the encoded operator interface transmission signals over the corresponding wireless communications link 310A-N and decode the received signals to develop corresponding operator interface signals 312A-N that are then applied to the computer system 304A-N.

The wireless communications modules 314A-N may utilize any of a variety of suitable wireless communications protocols in generating and receiving the encoded operator interface transmission signals over the communications links 310A-N, as will be appreciated by those skilled in the art. For example, the wireless communications modules 314A-N may communicate over the wireless communications links 310A-N using the Bluetooth wireless communications protocol. Also, the wireless communications protocol may include other features, such as throughput monitoring which monitors the data transfer rate on the communications link 310A-N being utilized. When the monitored data transfer rate is low, the operator interface transmission signals, which contain the information to be displayed on the display 322, are transmitted only when there is a change in the information to be displayed, as will be appreciated by those skilled in the art.

The wireless administration device 302 includes a wireless communications module 316 that operates in transmit and receive modes to communicate with the wireless communications modules 314A-N coupled to the computer systems 304A-N, respectively. More specifically, during the transmit mode the wireless communications module 316 receives encoded operator interface transmission signals from the respective wireless communications links 310A-N and decodes the received signals to develop corresponding operator interface signals 318 that are applied to an operator interface device 320. During the receive mode, the wireless communications module 316 receives operator interface signals 318 from the operator interface device 320 and encodes these signals to generate operator interface transmission signals that are then transmitted over the wireless communications links 310A-N to the wireless communications modules 314A-N.

The communication between the wireless communications module 316 and the wireless communications modules 314A-N is described as being via respective communications links 310A-N merely for ease of explanation. As will be appreciated by those skilled in the art, the wireless communications module 316 typically transmits operator interface transmission signals that include identification information corresponding to one of the wireless communications modules 314A-N. Each wireless communications module 314A-N receiving the transmitted identification information from the communications module 316 determines whether the transmitted operator interface transmission signals are directed to that particular wireless communications module 314A-N. Only the communications module 314A-N corresponding to the identification information decodes the transmitted operator interface transmission signals to generate operator interface signals 312A-N that are then applied to the corresponding computer system 304A-N.

In the wireless administration device 302, the operator interface device 320 provides output to and receives input from the system administrator to enable the administrator to select a desired computer system 304A-N and thereafter access the selected system, as will now be explained in more detail. The operator interface device 320 includes a video display 322 that displays administrator output information in response to the operator interface signals 318. A mouse 324 and keyboard 326 receive administrator input which is encoded in the form of the operator interface signals 318 that are then applied to the wireless communications module 316. In the embodiment of FIG. 3, the operator interface device 320 also includes a number of buttons that allow the system administrator to select the computer system 304A-N to be accessed. A manual connect button 328 allows the administrator to display on the video display 322 a list of available computer systems 304A-N that may be accessed. Once the list of available systems 304A-N is displayed, a previous button 330 and next button 332 allow the administrator to scroll through the displayed list to identify a desired or current computer system, which is then selected through a select current button 334. The operator interface device 320 allows the system administrator to remotely control the selected computer system 304A-N as if the administrator were using a conventional hardwired interface device (i.e., keyboard, video display, and mouse) coupled directly to the selected computer system.

A variety of other operator interface components may be contained in operator interface device 320, as will be appreciated by those skilled in the art. For example, in another embodiment the buttons 328-334 are replaced by a touch screen and stylus, with the equivalents of the buttons 328-334 being displayed on the video display 322 and the administrator using the stylus to activate the buttons via the touch screen.

The overall operation of the computer administration system 300 will now be described in more detail. In operation, the wireless administration device 302 operates in a selection mode and a control mode to allow the system administrator to select a desired computer system 304A-N and to thereafter access the selected system. In the selection mode of operation, the operator interface device 320 displays a list of available computer systems 304A-N that may be accessed by the administrator. Because the wireless administration device 302 is portable, this list of available computer systems 304A-N is a function of the physical location of the wireless administration device 302 relative to the computer systems 304A-N.

The operator interface device 320 and wireless communications module 316 contained in the wireless administration device 302 operate in combination with the wireless communications modules 314A-N to generate and display the list of available computer systems 304A-N. The specific process by which the list of available computer systems 304A-N is generated during the selection mode of operation depends on the wireless communications protocol being used on the wireless communications links 310A-N, as will be appreciated by those skilled in the art. For example, when the Bluetooth protocol is being utilized this protocol includes a service discovery protocol through which computer systems 304A-N proximate the wireless administration device 302 are discovered, connected to, and synchronized with the wireless administration device.

In one embodiment, the system 300 operates in the following manner during the selection mode of operation. To initiate the selection mode, the system administrator activates the manual connect button 328. In response to the manual connect button 328 being activated, any wireless communications link 310A-N currently established between the wireless communications module 316 and any of the wireless communications modules 314A-N is placed in a standby mode. The wireless communications module 316 thereafter receives beacons from all the wireless communications modules 314A-N proximate the wireless administration device 302. In this embodiment, each of the wireless communications modules 314A-N periodically transmits a beacon over the associated link 310A-N, with the beacon including information identifying the associated computer system 304A-N. The beacon typically also includes other protocol-related information, such as the data transfer rate of the associated communications link 310A-N, as will be appreciated by those skilled in the art.

For each beacon received by the communications module 316, the module applies corresponding operator interface signals 318 to the operator interface device 320 which, in turn, displays on the display 322 the identification information for the associated computer system 304A-N. Once the beacons for all the computer systems 304A-N proximate the wireless administration device 302 have been displayed, the system administrator thereafter utilizes the previous button 330, next button 332, and select current button 334 as previously described to select the desired computer system 304A-N to be accessed. As previously mentioned, in an alternative embodiment the buttons 328-334 are replaced by a touch screen and stylus, which the system administrator utilizes to select the desired computer system 304A-N. The list of available computer systems 304A-N displayed in the selection mode may also be updated automatically as the position of the wireless administration device 302 changes. Once the desired computer system 304A-N has been selected, the wireless administration device 302 commences operation in the control mode, allowing the system administrator to use the operator interface device 320 to control the computer system as required and take necessary actions.

With the computer administration system 300, the system administrator may easily access the computer systems 304A-N in the computer network 308. The wireless administration device 302 is portable, allowing the system administrator to be physically located near the computer system 304A-N being accessed which, as previously mentioned, may be desirable when the administrator is updating software or troubleshooting the computer system. Moreover, the administration system 300 requires no special software be loaded on the computer systems 304A-N, and thus requires no additional software be maintained by the system administrator. In addition, the administration system 300 requires no special hardware be added to the computer systems 304A-N since the operator interface signals 312A-N are standard signals typically utilized to provide operator interface to conventional computer systems.

In an alternative embodiment of the computer administration system 300, one or more of the computer systems 304A-N has an associated local operator interface device 336A-N, which is coupled to the computer system through the associated wireless communications module 314A-N. In this embodiment, each wireless communications module 314A-N operates in either a pass-through mode or a remote access mode. In the pass-through mode, each wireless communications module 314A-N couples the local operator interface device 336A-N directly to the associated computer system 304A-N, allowing a local user to access the computer system via the local operator interface device. During the remote access mode, each wireless communications module 314A-N operates as previously described to allow the system administrator to access the associated computer system 304A-N through the wireless administration device 302. The system administrator or the operator of the wireless administration device 302 controls whether a particular wireless communications module 314A-N operates in either the pass-through a remote access mode through associated controls (not shown) on the wireless administration device 302. This embodiment may be used, for example, in a computer lab scenario where an instructor has possession of the wireless administration device 302 and the communications modules 314A-N normally operate in the pass-through mode to provide students with access to the computer systems 304A-N through the local operator interface devices 336A-N. When the instructor has a need to take control of a particular computer system 304A-N, the instructor utilizes the wireless administration device 302 to place the corresponding wireless communications module 314A-N in the remote access mode of operation, and thereafter takes control of the associated computer system 304A-N to perform desired actions.

It is to be understood that even though various embodiments and advantages of the present invention have been set forth in the foregoing description, the above disclosure is illustrative only, and changes may be made in detail, and yet remain within the broad principles of the invention. For example, many of the components described above may be implemented using either digital or analog circuitry, or a combination of both, and also, where appropriate, may be realized through software executing on suitable processing circuitry. Therefore, the present invention is to be limited only by the appended claims.

1. A computer administration system for accessing computer systems in a computer network, each computer system being adapted to provide operator interface data signals containing user output information and being adapted to receive operator interface data signals containing user input information, the computer administration system comprising:
a plurality of system communications devices, each system communications device being adapted to be coupled to a corresponding computer system and operable in a transmit mode to receive the operator interface data signals from the corresponding computer system and to generate corresponding operator interface transmission signals, and operable in a receive mode to receive operator interface transmission signals and to generate corresponding operator interface data signals that are applied to the corresponding computer system; and
a remote access device, comprising,
a remote communications device operable to select a system communications device and operable during the transmit mode to receive the operator interface transmission signals from the selected system communications device and to generate corresponding operator interface data signals, and operable during the receive mode to receive operator interface data signals and generate corresponding operator interface transmission signals that are applied to the selected system communications device; and
an operator interface device coupled to the remote communications device and adapted to accept user input and provide user output, the operator interface device operable to generate user output in response to the operator interface data signals from the remote communications device, and operable in response to user input to apply corresponding operator interface data signals to the remote communications device.

2. The computer administration system of claim 1 wherein the operator interface data signals comprise keyboard, mouse, and video signals.

3. The computer administration system of claim 1 wherein the remote communications device receives the operator interface transmission signals from the selected system communications device and applies the operator interface transmission signals to the selected system communications device via a wireless communications link.

4. The computer administration system of claim 1 wherein the remote communications device further operates to identify the system communications devices proximate the remote access device and the operator interface device allows a desired identified system communications device to be selected.

5. The computer administration system of claim 4 wherein the user output generated by the operator interface device comprises a list of system communications devices and the operator interface device comprises a plurality of buttons that allow the desired identified system communications device to be selected.

6. The computer administration system of claim 5 wherein the buttons comprise a manual connect, previous, next, and select current buttons that allow the desired identified system communications device to be selected.

7. The computer administration system of claim 5 wherein the operator interface device further comprises a touch screen and the plurality of buttons are displayed on the touch screen display.

8. The computer administration system of 1 wherein the operator interface signals are encoded for transmission by the transmitting system communications device or remote communications device and are decoded by the receiving system communications device or remote communications device.

9. The computer administration system of claim 3 wherein each wireless communications link comprises a communications link communicating via the Bluetooth protocol.

10. A remote administration device for accessing computer systems in a computer network, each computer system being adapted to provide operator interface signals containing user output information and being adapted to receive operator interface signals containing user input information, the remote administration device comprising:
a remote communications device being operable to select a computer system and to receive from the selected computer system via a wireless communications link operator interface signals containing user output information, and to transmit to the selected computer system via the wireless communications link operator interface signals that supply user input information to the computer system; and
an operator interface device coupled to the remote communications device and operable to generate user output in response to the operator interface signals received by the remote communications device, and operable in response to user input to apply corresponding operator interface signals to the remote communications device for transmission to the computer system.

11. The remote administration device of claim 10 wherein the operator interface signals comprise keyboard, mouse, and video signals.

12. The remote administration device of claim 10 wherein the remote communications device selects a computer system by identifying computer systems proximate the remote communications device and the operator interface device allows a desired identified computer system to be selected.

13. The remote administration device of claim 12 wherein the user output generated by the operator interface device comprises a list of computer systems and the operator interface device comprises a plurality of buttons that allow the desired identified system communications device to be selected.

14. The remote administration device of claim 13 wherein the buttons comprise a manual connect, previous, next, and select current buttons that allow the desired identified system communications device to be selected.

15. The remote administration device of claim 13 wherein the operator interface device further comprises a touch screen and the plurality of buttons are displayed on the touch screen display.

16. A computer administration system for accessing computer systems in a computer network, each computer system being adapted to provide operator interface data signals containing user output information and being adapted to receive operator interface data signals containing user input information, and each computer system including a local operator interface device, the computer administration system comprising:
a plurality of system communications devices, each system communications device being adapted to be coupled to a corresponding computer system, and
operable in a local-user mode to apply the operator interface data signals from the computer system to the local operator interface device to allow the computer system to be controlled through the local operator interface device, and
operable in an override mode to inhibit control of the computer system through the local operator interface device and to operate in a transmit submode to receive the operator interface data signals from the corresponding computer system and to generate corresponding operator interface transmission signals, and to operate in a receive submode to receive operator interface transmission signals and to generate corresponding operator interface data signals that are applied to the corresponding computer system; and
a remote access device, comprising,
a remote communications device operable to select a system communications device and operable during the transmit submode to receive the operator interface transmission signals from the selected system communications device and to generate corresponding operator interface data signals, and operable during the receive submode to receive operator interface data signals and generate corresponding operator interface transmission signals that are applied to the selected system communications device; and
an operator interface device coupled to the remote communications device and adapted to accept user input and provide user output, the operator interface device operable to generate user output in response to the operator interface data signals from the remote communications device, and operable in response to user input to apply corresponding operator interface data signals to the remote communications device.

17. The computer administration system of claim 16 wherein the operator interface data signals comprise keyboard, mouse, and video signals.

18. The computer administration system of claim 16 wherein the remote communications device receives the operator interface transmission signals from the selected system communications device and applies the operator interface transmission signals to the selected system communications device via a wireless communications link.

19. The computer administration system of claim 18 wherein the remote communications device further operates to identify the system communications devices proximate the remote access device and the operator interface device allows a desired identified system communications device to be selected.

20. The computer administration system of claim 19 wherein the user output generated by the operator interface device comprises a list of system communications devices and the operator interface device comprises a plurality of buttons that allow the desired identified system communications device to be selected.

21. The computer administration system of claim 20 wherein the buttons comprise a manual connect, previous, next, and select current buttons that allow the desired identified system communications device to be selected.

22. The computer administration system of claim 20 wherein the operator interface device further comprises a touch screen and the plurality of buttons are displayed on the touch screen display.

23. The computer administration system of 18 wherein the operator interface signals are encoded for transmission by the transmitting system communications device or remote communications device and are decoded by the receiving system communications device or remote communications device.

24. The computer administration system of claim 18 wherein each wireless communications link comprises a communications link communicating via the Bluetooth protocol.

25. A computer administration system for accessing computer systems in a computer network, each computer system being adapted to provide operator interface data signals containing user output information and being adapted to receive operator interface data signals containing user input information, the computer administration system comprising a plurality of system communications devices, each system communications device being adapted to be coupled to a corresponding computer system; and a remote access device coupled to the system communications devices and including a remote communications device and an operator interface device.

26. The computer administration system of claim 25 wherein the operator interface data signals comprise keyboard, mouse, and video signals.

27. The computer administration system of claim 25 wherein the remote access device is coupled to the system communications devices via respective wireless links.

28. The computer administration system of claim 25 wherein the operator interface device comprises a plurality of buttons.

29. The computer administration system of claim 25 wherein the operator interface device comprises a touch screen and a plurality of buttons are displayed on the touch screen display.

30. A computer administration system for accessing computer systems in a computer network, each computer system being adapted to provide operator interface data signals containing user output information and being adapted to receive operator interface data signals containing user input information, the computer administration system comprising:
a plurality of system communications means that is each adapted to be coupled to a respective computer system for receiving the operator interface data signals from the corresponding computer system and generating corresponding operator interface transmission signals in a transmit mode, and for receiving operator interface transmission signals and generating corresponding operator interface data signals that are applied to the corresponding computer system in a receive mode; and
a remote access means for remotely controlling respective computer systems, the remote access means comprising,
a remote communications means for selecting a system communications device, and for receiving the operator interface transmission signals from the selected system communications device and generating corresponding operator interface data signals during the transmit mode, and for receiving operator interface data signals and generating corresponding operator interface transmission signals that are applied to the selected system communications means during the receive mode; and
an operator interface means for generating user output in response to the operator interface data signals from the remote communications means, and for applying operator interface data signals to the remote communications means in response to corresponding user input.

31. The computer administration system of claim 30 wherein the operator interface data signals comprise keyboard, mouse, and video signals.

32. The computer administration system of claim 30 wherein the remote communications means receives the operator interface transmission signals from the selected system communications means and applies the operator interface transmission signals to the selected system communications means via a wireless communications link.

33. The computer administration system of claim 32 wherein the remote communications means further includes means for identifying the system communications means proximate the remote access means and the operator interface means allows a desired identified system communications means to be selected.

34. The computer administration system of claim 4 wherein the user output generated by the operator interface means comprises a list of system communications devices and the operator interface means comprises a plurality user input means for allowing the desired identified system communications device to be selected.

35. The computer administration system of 32 wherein the operator interface signals are encoded for transmission by the transmitting system or remote communications means and are decoded by the receiving system or remote communications means.

36. The computer administration system of claim 32 wherein each wireless communications link comprises a communications link communicating via the Bluetooth protocol.

37. A computer network, comprising:
a plurality of computer systems, each computer system being adapted to provide operator interface data signals containing user output information and being adapted to receive operator interface data signals containing user input information;
a plurality of system communications devices, each system communications device coupled to a corresponding computer system and operable in a transmit mode to receive the operator interface data signals from the corresponding computer system and to generate corresponding operator interface transmission signals, and operable in a receive mode to receive operator interface transmission signals and to generate corresponding operator interface data signals that are applied to the corresponding computer system; and
a remote access device, comprising,
a remote communications device operable to select a system communications device and operable during the transmit mode to receive the operator interface transmission signals from the selected system communications device and to generate corresponding operator interface data signals, and operable during the receive mode to receive operator interface data signals and generate corresponding operator interface transmission signals that are applied to the selected system communications device; and
an operator interface device coupled to the remote communications device and adapted to accept user input and provide user output, the operator interface device operable to generate user output in response to the operator interface data signals from the remote communications device, and operable in response to user input to apply corresponding operator interface data signals to the remote communications device.

38. The computer administration system of claim 37 wherein at least some of the computer systems comprise servers.

39. The computer administration system of claim 37 wherein at least some of the computer systems comprise workstations.

40. The computer administration system of claim 37 wherein the operator interface data signals comprise keyboard, video, and visual display signals.

41. The computer administration system of claim 37 wherein at least some of the computer systems comprise local operator interface devices and each corresponding system communications device is operable in a pass-through mode to couple the operator interface data signals between the local operator interface device and the computer system to allow the local operator interface device to control the computer system, and is operable in an override mode to operate in the transmit and receive modes to allow the remote access device to control the computer system.

42. The computer administration system of claim 37 wherein the remote communications device receives the operator interface transmission signals from the selected system communications device and applies the operator interface transmission signals to the selected system communications device via a wireless communications link.

43. The computer administration system of claim 37 wherein the remote communications device further operates to identify the system communications devices proximate the remote access device and the operator interface device allows a desired identified system communications device to be selected.

44. The computer administration system of claim 43 wherein the user output generated by the operator interface device comprises a list of system communications devices and the operator interface device comprises a plurality of buttons that allow the desired identified system communications device to be selected.

45. The computer administration system of claim 44 wherein the buttons comprise a manual connect, previous, next, and select current buttons that allow the desired identified system communications device to be selected.

46. The computer administration system of claim 44 wherein the operator interface device further comprises a touch screen and the plurality of buttons are displayed on the touch screen display.

47. The computer administration system of 37 wherein the operator interface signals are encoded for transmission by the transmitting system communications device or remote communications device and are decoded by the receiving system communications device or remote communications device.

48. The computer administration system of claim 42 wherein each wireless communications link comprises a communications link communicating via the Bluetooth protocol.

49. A method of accessing computer systems in a computer network, each computer system being adapted to provide operator interface signals containing user output information and being adapted to receive operator interface signals containing user input information, the method comprising:
encoding the operator interface signals from each computer system;
transmitting the encoded operator interface signals via respective wireless links;
selecting one of the computer systems;
receiving the transmitted encoded operator interface signals from the selected computer system;
decoding the received operator interface signals;
displaying user information at a location remote from the computer system in response to the decoded operator interface signals;
receiving operator input at the remote location and generating corresponding operator interface signals responsive to the operator input;
encoding the generated operator interface signals; and
transmitting the encoded operator interface signals to the selected computer system via a wireless protocol.

50. The method of claim 49 wherein the operator interface signals comprise keyboard, video, and mouse signals.

51. The method of claim 49 wherein selecting one of the computer systems comprises selecting one of the computer systems that is proximate the remote location.
